(19) United States
(12) Patent Application Publication
(10) Pub. No.: US 2017/0116681 A1
(43) Pub. Date: Apr. 27, 2017

(54) System and method for monitoring income of cash based business

(71) Applicant: Alina Deibler, Phoenix, AZ (US)

(72) Inventor: Alina Deibler, Phoenix, AZ (US)

(21) Appl. No.: 14/923,064

(22) Filed: Oct. 26, 2015

(51) Int. Cl. G06Q 40/00

(52) U.S. Cl. CPC G06Q 40/123

(57) ABSTRACT

The disclosure depicts a system and method of enabling and encouraging tax based businesses to accurately report cash income to a tax collecting agency. The invention also provides a system and method enabling a tax collecting agency to monitor cash income of cash based businesses.

### REFERENCE TO RELATED APPLICATIONS

This application claims priority based upon pending U.S. patent application Ser. No. 11/692,110, filed on Mar. 27, 2007. Application Ser. No. 11/692,110 is a continuation in part of U.S. patent application Ser. No. 11/300,063, which was filed on Dec. 14, 2005. Both of these applications remain pending.

Application Ser. No. 11/692,110, filed on Mar. 27, 2007 is hereby incorporated into this application by reference. U.S. patent application Ser. No. 11/300,063, filed on Dec. 14, 2005, is hereby incorporated into this application by reference.

### FIELD OF INVENTION

This invention relates to a system and method of enabling and encouraging tax based businesses to accurately report cash income to a tax collecting entity. The invention also provides a system and method enabling a tax collecting entity to monitor cash income of cash based businesses.

### SUMMARY OF THE INVENTION

The invention is a method that enables a user to report cash income to a tax collecting entity. Specifically, the method requires the steps of providing the user with at least one user computer, providing a verification computer, and providing the tax collecting entity with at least one entity computer.

The inventive method also requires the step of forming a communication link between the at least one user computer, the verification computer, and the at least one entity computer. Moreover, the invention will also require the step of prompting the user to enter an identification number (such as an employer identification number or taxpayer identification number) into the at least one user computer. Thereupon, one performs the step of entering the identification number into the at least one user computer. For example, one embodiment of the inventive requires the user computer to comprise a tax cab meter.

The inventive method also requires the step of transmitting the identification number to the verification computer and verifying the identification number via a computer connection to the verification computer. The method will also require one to compare the identification number against a list of known valid identification numbers. Further, the invention prompts the user to enter vehicle usage data relating to a vehicle into the at least one user computer, and record into the at least one user computer an amount of cash income received by the user. This data input by the user is transmitted to the at least one computer of the tax collecting entity.

The tax collecting entity computer will formulate an estimated amount of cash income paid to the user, and it will also calculate a difference between the estimated amount of cash income paid to the user and the cash income received by the user. The inventive method will also require the tax collecting entity computer to notify the user of one of an entitlement to a benefit when the difference is within a preselected range and the assessment of a penalty when the difference exceeds the preselected range.

In an alternate preferred embodiment of the inventive method, the vehicle usage data may include mileage of the vehicle, fuel consumed by the vehicle, fuel purchased for the vehicle, equipment purchased for the vehicle, repairs done to the vehicle, times and dates of usage of the vehicle, or other maintenance data pertaining to the vehicle. Vehicle usage data may include the gross income (cash income and other income) of the vehicle, the amount of tips received with respect to the vehicle, and the vehicle identification number.

When the tax collecting entity formulates its estimated cash income of the business, a preferred embodiment of the inventive method requires the at least one tax collecting entity computer to correlate vehicle usage data with gross income.

The invention is also a method enabling a tax collecting entity to monitor income associated with a cash based business. The method requires the steps of providing at least one computer to the cash based business, providing at least one computer to the tax collecting entity, registering the cash based business with the tax collecting entity, and assigning an identification number to be associated with the cash based business.

The invention will also require the step of compiling data from each computer of the at least one computer used by the cash based business to record an amount of cash income received by the cash based business, and estimating, by the cash based business, an estimated amount of cash income associated with the cash based business. Also, the method requires the step of transmitting the amount of cash income received by the business to the at least one computer of the tax collecting entity. This embodiment of the invention will also compel the tax collecting entity to receive data relating to the cash income recorded by the at least one computer used by the cash based business.

The invention also requires the step of transmitting the estimated amount of the cash income to the at least one computer of the tax collecting entity, which will in turn receive this data relating to the estimated amount of the cash income associated with the cash based business. The method requires the step of determining a difference between the cash income from the estimated amount of cash income.

In a preferred embodiment, the income associated with a cash based business includes employee tips. In another preferred, embodiment of the method, the at least one computer of the tax collecting entity transmits an offer of a benefit to the at least one computer used by the business, wherein the offer of a benefit is transmitted only when the difference is less than a preselected amount. The offer of a benefit may include an offer of reduced rent for at least one employee of the business, an offer of tuition at a higher education institution for at least one employee of the business, an offer of medical coverage for at least one employee of the business, or an offer of retirement income for at least one employee of the business.

In a preferred alternate embodiment of the invention, the method may include the step of assessing a penalty upon the cash based business when the difference exceeds a preselected figure. An alternate embodiment equates the identification number with the federal tax identification number or the Employer Identification Number. Moreover, one may optionally use a taxi cab meter or a cash register as the user computer.

The invention is also system for monitoring cash income and tips associated with an individual cash based business by a tax collecting entity. The system will have at least one computer used by the cash based business, and at least one computer used by the tax collecting entity. An an identification number will be associated with the cash-based business, and a link enabling communication from the at least one computer used by the tax collecting entity with the at least one computer used by the cash based business.

The invention requires the at least one computer used by the cash based business to receive data relating to gross income of the cash based business, and calculate an estimated amount of the cash income of the cash based business. Moreover, the at least one computer used by the cash based business is configured transmit the estimated amount of the cash income of the cash based business and the gross income of the cash based business to the at least one computer operated by the tax collecting entity. Further, the at least one computer operated by the tax collecting entity calculates a difference between the estimated amount of the cash income and the gross cash income of the cash based business, and also transmits to the at least one computer of the cash based business an offer of a benefit when the difference is lower than a preselected amount.

In an alternate preferred embodiment of the system, the offer of a benefit comprises one of an offer of reduced rent for at least one of the employees of the business; an offer of tuition at a higher education institution for employees of the business; an offer of medical coverage for employees of the business; and, an offer of retirement income employees of the business.

Moreover, the identification number may be a federal tax identification number and an Employer Identification Number, for example.

The invention is also a method of enabling a tax collecting entity to monitor tax liability related to income of a cash based business. The method will include the steps of providing at least one computer to the tax collecting entity, providing at least one computer to the cash based business, and assigning an identification number to the business.

The invention will also require the step of providing a communications link enabling the at least one computer of the tax collecting entity to obtain data from the at least one computer of the cash based business. The invention will also require communicating, by the at least one tax collecting entity computers, with one or more computers used by the business to record cash flow received by the business.

The inventive method further requires receiving, by the one or more tax collecting entity computers, data relating to at least one of hours worked and gross income of the cash based business, and calculating an estimated amount of cash income associated with the individual cash based business. The inventive method will also include the step of receiving, by the at least one tax collecting entity computer, data relating to the cash income recorded by the at least one computer used by the business, and determining a difference, by the at least one tax collecting entity computer, between the estimated amount of cash income and the cash flow received by the business.

The invention also requires transmitting, by the one or more tax collecting entity computers, an offer of a benefit to the business when a preselected number exceeds the difference.

In a preferred embodiment of the inventive method, the offer of a benefit comprises at least one of an offer of reduced rent for one or more employees of the business; an offer of tuition at a higher education institution employees of the business; an offer of medical coverage for employees of the business; retirement income for employees of the business.

Preferably, the estimated amount of cash income is calculated by the at least one computer of the tax collecting entity based upon data relating to the number of hours worked and gross income of the individual cash based business.

The invention is also a method enabling a tax collecting entity to monitor income associated with a cash based business. The method requires the steps of providing at least one computer to the cash based business, providing at least one computer to the tax collecting entity, registering the cash based business with the tax collecting entity, and assigning an identification number to be associated with the cash based business.

The invention will also require the step of compiling data from each computer of the at least one computer used by the cash based business to record an amount of cash income received by the cash based business, and estimating, by the cash based business, an estimated amount of cash income associated with the cash based business. Also, the method requires the step of transmitting the amount of cash income received by the business to the at least one computer of the tax collecting entity. This embodiment of the invention will also compel the tax collecting entity to receive data relating to the cash income recorded by the at least one computer used by the cash based business.

The invention also requires the step of transmitting the estimated amount of the cash income to the at least one computer of the tax collecting entity, which will in turn receive this data relating to the estimated amount of the cash income associated with the cash based business. The method requires the step of determining a difference between the cash income from the estimated amount of cash income.

In a preferred embodiment, the income associated with a cash based business includes employee tips. In another preferred embodiment of the method, the at least one computer of the tax collecting entity transmits an offer of a benefit to the at least one computer used by the business, wherein the offer of a benefit is transmitted only when the difference is less than a preselected amount. The offer of a benefit may include an offer of reduced rent for at least one employee of the business, an offer of tuition at a higher education institution for at least one employee of the business, an offer of medical coverage for at least one employee of the business, or an offer of retirement income for at least one employee of the business.

In a preferred alternate embodiment of the invention, the method may include the step of assessing a penalty upon the cash based business when the difference exceeds a preselected figure. Additionally, an alternate embodiment equates the identification number with the federal tax identification number or the Employer Identification Number. Moreover, one may optionally use a taxi cab meter or a cash register as the user computer.

Other objects, advantages and novel features of the present invention will become apparent from the following detailed description of the invention when considered, in conjunction with the accompanying drawings.

### BRIEF DESCRIPTION OF THE DRAWINGS

FIG. 1 provides a flow chart diagram of steps involved in a method that enables a user to report cash income to a tax collecting entity, according to the principles of the invention.

FIG. 2 provides a flow chart diagram of steps involved in a second preferred embodiment of a method that enables a user to report cash income to a tax collecting entity, according to the principles of the invention.

FIG. 3 shows the components of a system that enables a user to report cash income to a tax collecting entity, according to the principles of the invention.

### DETAILED DESCRIPTION OF THE PREFERRED EMBODIMENTS

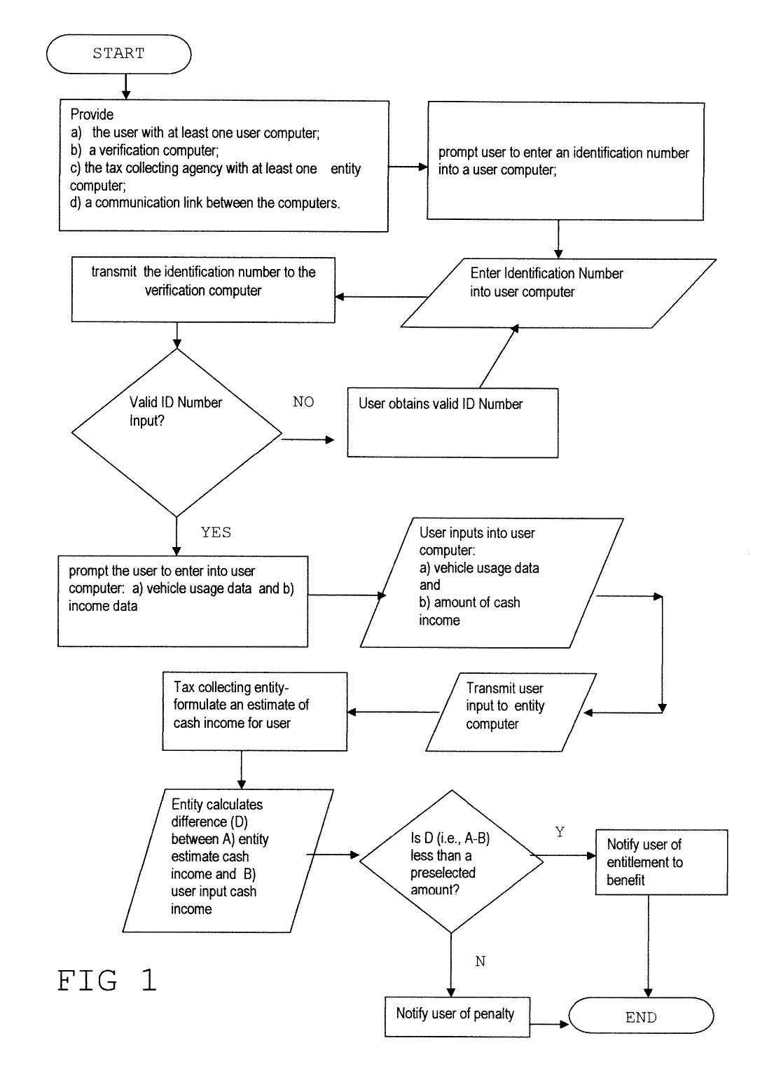

FIG. 1 provides a flow chart diagram of the inventive method that enables a user to report cash income to a tax collecting entity. The method requires one to provide a user, preferably a cash-based business, with at least one computer. The method also requires a verification computer. The verification computer performs important functions, inter alia, ascertaining the identity of the cash-based business, and should include measures implemented to protect and preserve the integrity of important private financial data.

Still referring to FIG. 1, the inventive method also requires one to provide the tax collecting entity with at least one entity computer, and the method further requires the step of establishing linking all three computers. Indeed, the method requires a communication link from each computer to the other two.

The inventive method depicted in FIG. 1 also requires a user to input an identification number into a user computer. Of course, each user should be assigned a unique identifier, such as a Taxpayer Identification Number or Social Security Number, for the purpose of identification, verification, and classification of the respective data. Once a user inputs an identification number into the user computer, the same is transmitted to the verification computer. Of course, the inventive system may require a user to establish its right to enter data by requiring the input of a username, identification number and/or password before being allowed to proceed.

Still referring to FIG. 1, once the data is transmitted to the verification computer, the verification computer runs an algorithm that validates the input data before enabling a user to input important data. If the verification computer ascertains a lack of valid input the user is denied access to proceed further, and is redirected to either re-enter or obtain valid credentials.

As shown in FIG. 1, if the verification computer determines that valid ID was input by the user, the user is prompted to enter data. For example, the user may be prompted for information regarding vehicle usage, services provided, an inventor inventory of items sold, names and identities of parties to transactions. Of course, the user may also be prompted to input an amount of cash income received from each transaction or from an aggregate of periodic (i.e., such as dally or hourly) transactions.

Still referring to FIG. 1, the inventive method will also require the user to respond to the prompt by entering data requested at the prompt. Specifically, the user will respond to the prompt by inputting information regarding vehicle usage, services provided, an inventor inventory of items sold, names and identities of parties to transactions. Of course, the user may also input an amount of cash income received from each transaction or from an aggregate of periodic (i.e. , such as daily or hourly) transactions

Once a user inputs data into the user computer, the same is transmitted to the at least one computer of the tax collecting entity. The tax collecting entity then algorithmicaliy forms an estimate of the expected cash income. The entity, of course, will be able to compare past and present cash income figures from tens of thousands of businesses of various sizes and styles, and based upon this information the tax collecting entity computer will algorithmically formulate an estimate of cash income expected to be received by the cash business.

Still referring to FIG. 1, once the entity computer formulates an estimate of cash income for the user, the entity computer then performs the step of calculating a difference between its algorithmically-derived estimate of cash income on the one hand and the actual user input cash income on the other hand.

Still referring to FIG. 1, the inventive method will require the step of comparing the aforementioned difference to a preselected amount. The preselected amount, for example, is generally chosen by the tax-collecting entity to be a figure based upon a percentage of actual cash income reported. Alternatively, the preselected amount may be a dollar figure that can be graduated depending on the size of a business. For example, a small restaurant employing only ten persons may be given a threshold of ten or fifteen percent, whereas a larger business with numerous locations and hundreds of employees may have a preselected amount that is significantly more expansive. The setting of the preselected amount may best be delegated to the tax collecting entity—or even a matter allowed for public input—after considerable empirical study.

Once the difference and preselected amount are both calculated, the inventive method depicted in FIG. 1 requires the step of determining whether the difference is less than the preselected amount. If the difference is less than a preselected amount, the user is informed of an entitlement to a benefit. The benefit may include the offer of a benefit is transmitted only when the difference is less than a preselected amount. The offer of a benefit may include an offer of reduced rent for at least one employee of the business, an offer of tuition at a higher education institution for at least one employee of the business, an offer of medical coverage for at least one employee of the business, or an offer of retirement income for at least one employee of the business.

Still referring to FIG. 1, the inventive method will also include the step of notifying the user of a penalty in the event the difference is greater than (or equal to) a threshold amount. Of course, a preferred embodiment of the inventive method may also give a graduating scale of penalties, such as increased levels of penalty for larger discrepancies. Moreover, the inventive method may also include a series of steps that entitle a user to make changes and corrections to mitigate or eliminate penalty.

The inventive method of FIG. 1 enables tax collecting agencies and cash based businesses to share information with one another on a very near real-time basis. Under the current system, cash-based businesses make periodic reports to tax-collecting agencies, and these businesses may incur prohibitive costs and administrative expense in assembling these reports from analysis of company receipts. Additionally, the current system of reporting on a periodic basis gives rise to erroneous reporting, non-reporting, or even evasive fraud. The inventive method shown herein may reduce expensive administrative costs while increasing the amount of taxes paid by cash-based businesses.

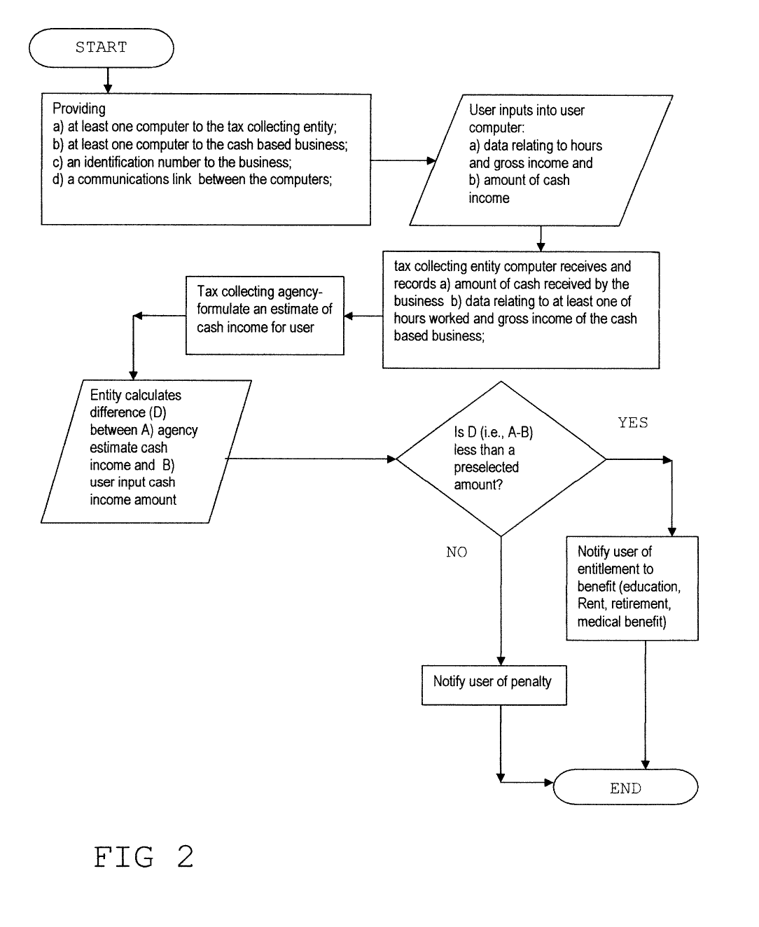

FIG. 2 shows a detailed flowchart detailing a second preferred embodiment of the invention. As shown, the invention includes the step of providing at least one computer to each of a tax collecting entity and a cash based business. The invention also requires the establishment of a communication link between the computers, and the assigning of an identification number to the business. The invention also requires the user to input into the user computer data relating to hours, gross income, and cash income received. For the purpose of this application, the term gross income approximates the generally-accepted formulaic definition: an accession to wealth, clearly realized, subject to the dominion and control of the business, from whatever source derived. In contrast, the term cash income includes, but is not limited to, immediately liquid receipts that can be immediately spent by the business without deposit or without conversion into another form.

Generally, cash income may also include gross income difficult to track and account for using a current set of technologies available for monitoring income. For example some forms of credit or debit card payment may be difficult to track, especially when a transaction includes portions for tips and gratuities (usually cash income) as well as payment for goods and services.

Still referring to FIG. 2, the invention also requires the step of receiving and recording, by the tax collecting entity computer the amount of cash received by the business as well as data relating to the amount of hours worked and gross income of the cash based business. The invention also compels the tax collecting entity to algorithmically formulate an estimate of cash income for the user. Generally, the tax collecting entity has access to thousands of similar businesses, and also has data relating to present and past businesses of similar size and breadth, so the tax collecting entity is able to algorithmically formulate a reasonable estimate for expected cash income of the cash based business.

As shown in FIG. 2, the inventive method also requires the tax collecting entity to calculate a difference between the estimated cash income on the one band, and the user's input cash income on the other hand. If this difference falls within a preselected range, then the tax collecting entity notifies the cash based business of its entitlement to a benefit. On the other hand, if the difference exceeds a preselected amount, the tax collecting entity may notify the cash based business of the assessment of a penalty.

Of course, the invention detailed in FIG. 2 may also be construed to allow the cash based business to avoid penalty by exhibiting exceptional or mitigating circumstances that justify or explain why the difference exceeds a preselected amount. The inventive steps may then be repeated as necessary, at periods and regular intervals. For example, the parties may agree to exchange data on a real-time basis, or may transmit data continually, or at discrete scheduled times, such as at the close of each business day or week.

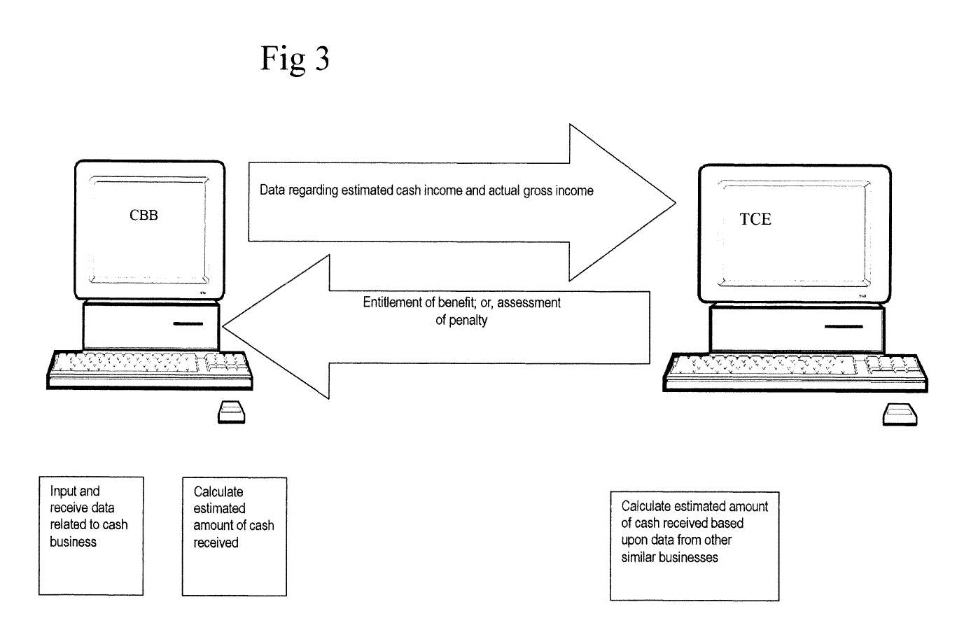

FIG. 3 details the components of an inventive system tailored to enable a cash based business and a tax collecting entity to better communicate with one another, thereby enabling a tax collecting entity to monitor income associated with a cash based business, and conversely casing the burdens confronting a cash based business of accounting for and reporting taxable cash income.

The inventive system shown in FIG. 3 will include at least one Cash Based Business computer CBB and at least one Tax Collecting Entity Computer TCE. The computers TCE and CBB are networked with one another to exchange information frequently; in a preferred embodiment of the invention, the exchange of information is spontaneous and a real-time exchange.

The cash based business computer CBB is configured to receive data input related to cash based businesses. It may also calculate a general estimate of cash received, based upon data input in the past, and perhaps based upon information from other sources. The CBB may comprise a network of connected devices. For example, the CBB may comprise numerous cash registers placed at various locations of a retail establishment, and the CBB may comprise numerous taxi cab meters in communication with a central server.

As shown in FIG. 3, the invention includes a communication link enabling efficient exchange of data regarding estimated cash income and actual gross income of the cash based business, as this data is transmitted to the at least TCE computer. In turn, the Tax Collecting Entity Computer TCE may comprise a network of devices configured to transmit an entitlement of a benefit or a penalty to the cash based business computer CBB.

Still referring to FIG. 3, the TCE Computer should be configured to algorithmically calculate an estimated amount of cash income expected to be received by the cash based business. This estimate will be calculated based upon a statistical and demographic analysis of similar businesses. For example, the estimated amount of cash income may be calculated by the at least one computer of the tax collecting entity based upon data relating to the number of hours worked and gross income of the individual cash based business.

The system shown in FIG. 3 is well-suited to enable immediate, real-time transfer of income information from cash-based business to tax collecting entities.

Although the present invention has been described and illustrated in detail, it is to be clearly understood that the same is by way of illustration and example only, and is not to be taken by way of limitation. The spirit and scope of the present invention are to be limited only by the appended claims that precisely define the metes and bounds of the invention.

I claim the following:

1. A method enabling a user to report cash income to a tax collecting entity, the method comprising the steps of:
providing the user with at least one user computer;
providing a verification computer;
providing the tax collecting entity with at least one entity computer;
forming a communication link between the at least one user computer, the verification computer, and the at least one entity computer;
prompting the user to enter an identification number into the at least one user computer;
entering the identification number into the at least one user computer;
transmitting the identification number to the verification computer;
verifying the identification number via a computer connection to the verification computer;
comparing the identification number against a list of known valid identification numbers;
prompting the user to enter vehicle usage data relating to a vehicle into the at least one user computer;
recording into the at least one user computer an amount of cash income received by the user;
transmitting data input by the user to the at least one computer of the tax collecting entity;
formulating, within the at least one computer of the tax collecting entity, an estimated amount of cash income paid to the user; and
calculating, within the at least one computer of the tax collecting entity, a difference between the estimated amount of cash income paid to the user and the cash income received by the user;
notifying, by the at least one computer of the tax collecting entity, the user of one of
an entitlement to a benefit when the difference is within a preselected range and
an assessment of a penalty when the difference exceeds the preselected range.

2. The method of claim 1, wherein the vehicle usage data comprises at least one of a mileage of the vehicle, money spent on fuel purchased for the vehicle; and time of use of the vehicle; and dates of use of the vehicle; and gross income generated by use of the vehicle; and tips generated from use of the vehicle.

3. The method of claim 1, wherein the step of formulating an estimated amount of income includes step of correlating, by the at least one computer of the tax collecting entity vehicle usage data with gross income.

4. The method of claim 1, wherein the identification number is a vehicle identification number.

5. The method of claim 1, wherein the identification number is a tax identification number.

6. The method of claim 1, wherein the at least one user computer comprises a taxi cab meter.

7. A method for monitoring income associated with a cash based business by a tax collecting entity, the method comprising the steps of:
providing at least one computer to the cash based business;
providing at least one computer to the tax collecting entity;
registering the cash based business with the tax collecting entity;
assigning an identification number to be associated with the cash based business;
compiling data from each computer of the at least one computer used by the cash based business to record an amount of cash income received by the cash based business;
estimating, by the cash based business an estimated amount of cash income associated with the cash based business;
transmitting the amount of cash income received by the business to the at least one computer of the tax collecting entity;
receiving, by the tax collecting entity, data relating to the cash income recorded by the at least one computer used by the cash based business; and
transmitting the estimated amount of the cash income to the at least one computer of the tax collecting entity;
receiving, by the tax collecting entity, data relating to the estimated amount of the cash income associated with the cash based business;
determining a difference between the cash income from the estimated amount of cash income.

8. The method of claim 7, wherein the income associated with a cash based business includes employee tips.

9. The method of claim 7, the at least one computer of the tax collecting entity being further configured to transmit an offer of a benefit to the at least one computer used by die business, wherein the offer of a benefit is transmitted only when the difference is less than a preselected amount.

10. The method of claim 9, wherein the offer of a benefit comprises at least one of:
an offer of reduced rent for at least one employee of the business; and,
an offer of tuition at a higher education institution for at least one employee of the business; and,
an offer of medical coverage for at least one employee of the business; and,
an offer of retirement income for at least one employee of the business.

11. The method of claim 7, further including the step of:
assessing a penalty upon the cash based business when the difference exceeds a preselected figure.

12. The method of claim 7, wherein the at least one computer used by the cash based business comprises one of a taxi cab meter or a cash register.

13. A system for monitoring cash income and tips associated with an individual cash based business by a tax collecting entity, the system comprising:
at least one computer used by the cash based business;
at least one computer used by the tax collecting entity;
an identification number associated with the cash-based business;
a link enabling communication from the at least one computer used by the tax collecting entity with the at least one computer used by the cash based business;
wherein, the at least one computer used by the cash based business is configured to receive data relating to gross income of the cash based business;
and wherein, the at least one computer used by the cash based business calculates an estimated amount of the cash income of the cash based business;
and wherein, the at least one computer used by the cash based business is configured transmit the estimated amount of the cash income of the cash based business and the gross income of the cash based business to the at least one computer operated by the tax collecting entity;
and wherein the at least one computer operated by the tax collecting entity calculates a difference between the estimated amount of the cash income and the gross cash income of the cash based business;
and wherein, the at least one computer of the tax collecting entity transmits to the at least one computer of the cash based business an offer of a benefit when the difference is lower than a preselected amount.

14. The system of claim 13, wherein the offer of a benefit comprises one of an offer of reduced rent for at least one of the employees of the business; an offer of tuition at a higher education institution for employees of the business; an offer of medical coverage for employees of the business; and, an offer of retirement income employees of the business.
